(19) United States
(12) Patent Application Publication
(10) Pub. No.: US 2006/0284474 A1
(43) Pub. Date: Dec. 21, 2006

(54) Vehicle wheel consisting of sheet metal, especially sheet steel

(76) Inventor: Klaus Bluemel, Dinslaken (DE)

Correspondence Address: PROSKAUER ROSE LLP;PATENT DEPARTMENT, 1585 BROADWAY, NEW YORK, NY, 10036-8299, US

(21) Appl. No.: 10/557,554

(22) PCT Filed: May 19, 2004
(86) PCT No.: PCT/EP04/05424

§ 371 Date: Aug. 21, 2006

(30) Foreign Application Priority Data
May 23, 2003 (DE) 103 23 833.6

(51) Int. Cl. B60B 3/10

(52) U.S. Cl. 301/63.101

(57) ABSTRACT

The invention relates to a sheet metal, especially sheet steel vehicle wheel consisting of a wheel rim (1) and a wheel disc (2). According to the invention, aeration openings (8) are provided in an annular region (7) surrounding the fixing region (5), and brackets (11) are connected to the radial outer edge of said openings, said brackets extending in the direction of the wheel rim bed and being rigidly connected thereto. In order to increase the rigidity of one such vehicle wheel and to improve the appearance thereof, the radial connecting elements left between the aeration openings (8) extend towards the fixing region (5) and are embodied as spokes (14) having a reinforcing form.

The invention relates to a sheet metal vehicle wheel, in particular of sheet steel, comprising a rim well and a rim having an outer and an inner rim flange and a wheel disc connected to the outer rim flange and supporting the rim well, which wheel disc includes a central fixing region and ventilation apertures in an annular region surrounding said fixing region, the wheel disc having a single-walled configuration and straps being attached to the radially outer edges of the ventilation apertures, which straps extend in the direction of the rim well and are rigidly connected thereto.

Sheet metal vehicle wheels are known in various embodiments. Vehicle wheels both of sheet steel and of sheet aluminium are known from practice and/or from the literature.

In a known vehicle wheel of sheet aluminium (DE 33 28 135 A1) the wheel disc is composed of two sheet metal preforms which firmly adjoin one another in the central fixing region and in the annular region surrounding this region, while they diverge from one another in the region close to the rim and lead to the rim flanges, where they are held in the latter by beading. The part leading to the inner rim flange additionally forms a support for the rim well.

In this known vehicle wheel the parts are held together solely by a positive fit. A disadvantage of such a vehicle wheel is that the wheel disc for such a fixing has a double-walled configuration.

In another known vehicle wheel (FR 843 614, in particular FIGS. 5 and 6) of the type mentioned in the introduction, the straps are formed by parts cut in the manner of tongues from the outer annular region of the wheel disc. The webs located between these cut areas have a flat configuration and lead to the middle region, which is continuous in the circumferential direction and borders the central fixing region. Such a vehicle wheel gives the optical impression of a substantially closed wheel disc with ventilation apertures in the outer annular region. Such a vehicle wheel is not comparable to the pleasing appearance of a cast aluminium wheel with spokes.

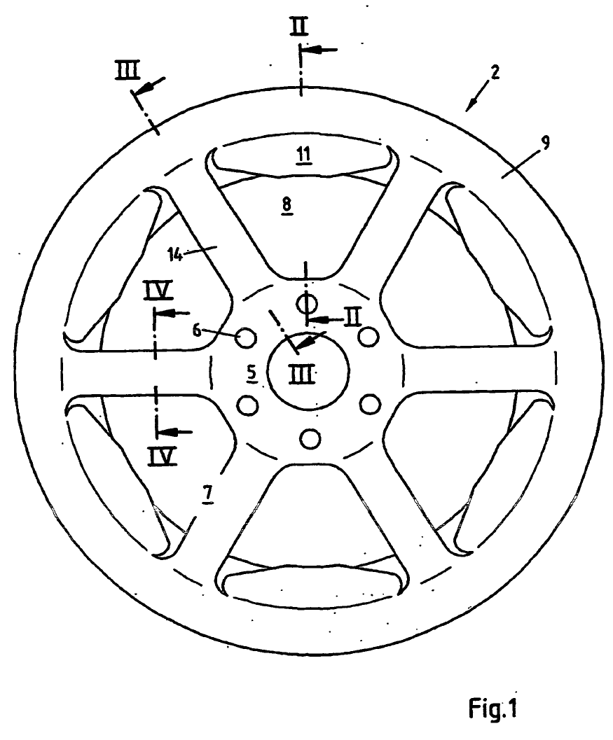

In a quite different known sheet metal vehicle wheel (DE 1 605 545 A, especially FIG. 1), which consists of a sheet metal rim and a middle part welded thereto, the region located outside the central fixing region is configured in the manner of spokes, the end of each spoke being welded to the rim. The spokes have a stiffening profile. In such a wheel the connection to the wheel rim only via the ends of the spokes is not optimal.

It is the object of the invention to provide a sheet metal vehicle wheel which is inexpensive and simple to produce and possesses a high degree of stiffness.

This object is achieved with a vehicle wheel of the kind mentioned in the introduction, in that the radial webs remaining between the ventilation apertures extend to the fixing region and are configured as spokes with stiffening profiling, the stiffening profiling having, in particular, an arcuate configuration. Because of this particular type of connection of the wheel disc to the wheel rim in conjunction with the configuration of the webs as spokes, the wheel according to the invention has high stiffness and at the same time the pleasing appearance of a spoked wheel.

Manufacture of the vehicle wheel involves low cost and complexity in particular if, according to an embodiment of the invention, the annular region includes tongue-like portions cut to form the ventilation apertures and the straps, the tongue-like cut portions that form the straps being connected to the wheel disc only via their radially outer edges and being oriented towards the inner side of the wheel. In this embodiment the wheel disc is formed in one piece. The straps therefore do not need to be separately attached to the wheel disc, for example, by welding or soldering.

The inherent stiffness of the vehicle wheel can be further increased in that cavities are formed between the straps and the rim. This can be optimised, in particular, if the rim well has a deep configuration.

It is especially advantageous with regard to manufacturing technology if the wheel disc is connected at its outer edge to the outer rim flange by a positive fit, in particular if the outer edge of the wheel disc forms a bead around the rim flange. This configuration also has a positive effect aesthetically. With regard to manufacturing technology it is further advantageous if the rim well and the straps of the wheel disc have a material-connected joint. For materials that are difficult to weld, MIG soldering is especially appropriate for the material-connected joint.

The thickness of the sheet metal of the rim and/or the wheel disc is preferably dimensioned in its axial and radial extensions according to the local loadings arising in operation. Accordingly, and for weight optimisation, the thickness of the sheet metal of the wheel disc, which in operation has a decreasing cross-sectional loading with increasing distance from the wheel axle, may be made correspondingly thinner. The weight-optimisation measures may be combined in manufacture, the thinning of the wheel disc and the beading of the rim flange being carried out in one work cycle.

To protect wheel disc and rim from corrosion, both parts may be made of corrosion-protected, in particular zinc-coated or aluminium-coated sheet steel. Alternatively, the rim and, in particular, the wheel disc that determines the optical appearance, may be made of special steel. For the wheel disc dual-phase steel, TRIP steel or LIP steel is especially suitable. For the rim, LIP steel is especially suitable.

The wheel disc may be manufactured by hot forming. In this case it is made of tempering steel, e.g. of grade 22 MnB 5. The sheet metal blank to be hot-formed may be heated to the required forming temperature outside or inside the forming tool. After forming, specified cooling takes place to establish material stability, preferably while the wheel disc is still in the forming tool.

The invention is explained in more detail below with reference to the drawings representing an embodiment, in which drawings:

FIG. 1 shows a vehicle wheel in elevation, viewed from the outer side;

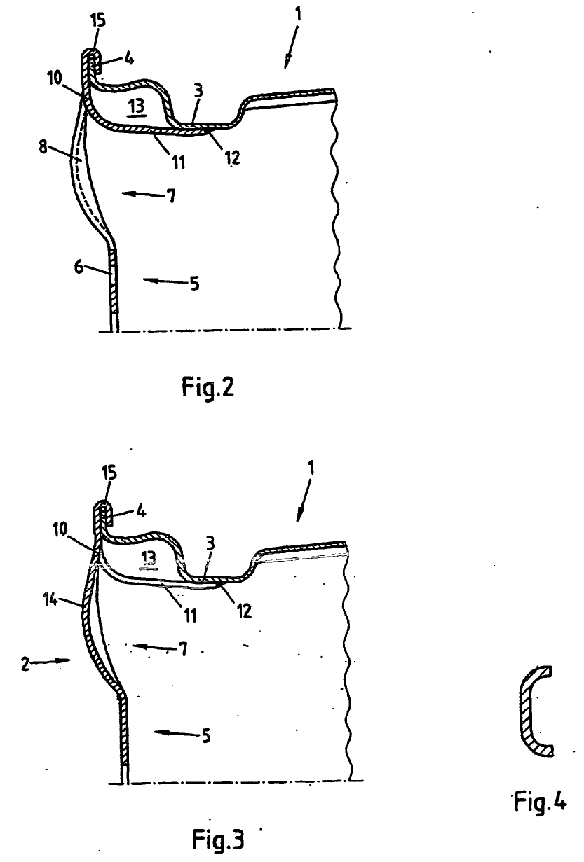

FIG. 2 shows the vehicle wheel according to FIG. 1 in partial cross-section along the line II-II of FIG. 1;

FIG. 3 shows the vehicle wheel according to FIG. 1 in partial cross-section along the line III-III of FIG. 1, and

FIG. 4 shows a vehicle wheel according to FIG. 1 in an enlarged partial cross-section along the line IV-IV of FIG. 1.

The vehicle wheel consists of two joined sheet metal preforms, i.e. a rim 1 and a wheel disc 2. Both the rim 1 and the wheel disc 2 are made of sheet steel.

The rim 1 has a rim well 3, configured as a deep well, and two flanges, only the outer flange 4 of which is represented in FIGS. 2 and 3.

The wheel disc 2 includes a central fixing region 5 with holes 6 for wheel bolts, an annular region 7 surrounding said fixing region 5 and having substantially trapezoidal ventilation apertures 8, and an outer annular region 9. To form the ventilation apertures 8, parts are cut from the continuous material in such a way that the cut parts are connected by their outer edges 10 in the manner of tongues. The cut parts are bent towards the inner side of the wheel and form straps 11. The straps 11 extend into the region of the deep well 3, where they fit in a supporting manner against the rim well and are joined by material connection thereto, in particular by a MIG solder joint 12. The straps 11 thus form with the rim 1 reinforcing, in particular torsionally stiff, cavities 13.

The radially disposed webs remaining between the apertures 8 form spokes 14. They are slightly curved outwardly and have in cross section a stiffening profiling, as shown in the detail section of FIG. 4. The stiffening profiling should be designed, in particular, to transmit high bending forces.

The wheel disc 2 is connected to the rim 1 not only via its straps 11 but also by its outer edge, the outer edge 15 of the wheel disc 2 extending form-fittingly around the outer rim flange 4.

1. Sheet metal vehicle wheel, in particular of sheet steel, comprising a rim well and a rim having an outer and an inner rim flange, and a wheel disc connected to the outer rim flange and supporting the rim well, which wheel disc includes a central fixing region and ventilation apertures in an annular region surrounding said fixing region, the wheel disc having a single-walled configuration and straps being connected to the radially outer edge of the ventilation apertures, which straps extend in the direction of the rim well and are rigidly connected to the rim well, wherein
the radial webs remaining between the ventilation apertures extend to the fixing region and are configured as spokes having a stiffening profiling, and the wheel disc is connected in a form-fitting manner to the outer rim flange by means of a beading formed by its outer edge.

2. Vehicle wheel according to claim 1, wherein
the stiffening profiling has arcuate configuration.

3. Vehicle wheel according to claim 1, wherein
the annular region includes tongue-like parts cut to form the ventilation apertures and the straps, the tongue-like cut parts that form the straps, being connected to the wheel disc only by their radially outer edges and being oriented towards the inner side of the wheel.

4. Vehicle wheel according to claim 1, wherein
cavities are formed between the straps and the rim.

5. Vehicle wheel according to claim 1, 4, wherein
the rim well is configured as a deep well.

6. Vehicle wheel according to claim 1, wherein
the outer edge of the wheel disc is connected in a form-fitting manner to the outer rim flange.

7. Vehicle wheel according to claim 6, wherein
the form-fitting connection is in the form of a beading formed by the outer edge of the wheel disc.

8. Vehicle wheel according to claim 1, wherein
the connection between the rim well and the straps of the wheel disc is a material-connected joint.

9. Vehicle wheel according to claim 8, wherein
the material-connected joint is a MIG solder joint.

10. Vehicle wheel according to claim 1, wherein
the thickness of the sheet metal of the rim is dimensioned in its axial extension according to the local loading arising in operation.

11. Vehicle wheel according to claim 1, wherein
the thickness of the sheet metal of the wheel disc is dimensioned in its radial extension according to the local loading arising in operation.

12. Vehicle wheel according to claim 1, wherein
the wheel and the rim are made of corrosion-protected, in particular zinc-coated or aluminium-coated sheet steel.

13. Vehicle wheel according to claim 1, wherein
the wheel disc is made of dual-phase steel, TRIP steel or LIP steel.

14. Vehicle wheel according to claim 1, wherein
the rim 4 is made of LIP steel.
